(19) United States
(12) Patent Application Publication
(10) Pub. No.: US 2012/0297031 A1
(43) Pub. Date: Nov. 22, 2012

(54) Anonymous Signalling

(76) Inventors: Xing Danielsson Fan, Lund (SE); Jan Patrik Persson, Lund (SE); Per Persson, Sodra Sandby (SE); Song Yuan, Lund (SE)

(21) Appl. No.: 13/220,327

(22) Filed: Aug. 29, 2011

Related U.S. Application Data
(60) Provisional application No. 61/486,509, filed on May 16, 2011.

(30) Foreign Application Priority Data
Aug. 23, 2011 (EP) PCT/EP2011/064473

(51) Int. Cl. G06F 15/16

(52) U.S. Cl. 709/219

(57) ABSTRACT

Embodiments include a method in a server for facilitating anonymous communication between a first web browser on a first communication device and a second web browser on a second communication device. The method includes dynamically establishing a signalling channel on the server for the first web browser responsive to the first web browser browsing to the server. The method further includes creating a unique identifier for the signalling channel, temporarily storing the unique identifier at the server, and then sending the unique identifier to the first web browser. The first communication device correspondingly sends the unique identifier to the second web browser, such an in an email or text message. Then, responsive to the second web browser browsing to the server using the unique identifier, the method includes connecting the second web browser to the established signaling channel for anonymous communication between the first and second web browsers over that channel.

### RELATED APPLICATIONS

This application claims priority to U.S. Provisional Application Ser. No. 61/486,509, filed May 16, 2011, and to International Application Serial No. PCT/EP2011/064473, filed Aug. 23, 2011, each of which is incorporated by reference in its entirety.

### TECHNICAL FIELD

Disclosed herein is a method for facilitating anonymous audio and video communication via web browsers.

### BACKGROUND

The use of voice, audio and video communication over the internet is ever increasing, and programs for enabling such communication typically referred to as Voice over Internet Protocol, VoIP, are widely used. Most services are no longer providing only voice communication, but include multimedia sessions, video communication, chat, etc. It is possible to perform such communication in a browser, e.g. by using a plug-in program such as Skype or Flash, which each have millions of users.

A standardization effort known as RTC-Web, Real Time Communication-Web, is picking up pace. The RTC-Web is based on evolved web technology, and will facilitate voice and video communication directly from a web browser, without the need for any plug-ins.

The RTC-Web approach requires an “out-of-band” signalling channel for establishing sessions. This channel is typically implemented using a web service, however, the exact details are not specified within the RTC-Web framework. The signalling channels passes messages between browsers, handles details such as media formats, adding/removing media stream, etc.

Using a web browser to establish a communication typically requires the user to login to a server and exchange some initial information. A server back-end, maintaining user names and passwords, and possibly more information, is thus required. This backend is not only complex to administer but could also be a target for intrusion attempts, such as seen by recent attacks to the Sony PlayStation Network.

### SUMMARY

Therefore one aspect of the present invention to provide a peer to peer communication system without requiring a user to log into a server maintaining a database of user information.

According to one or more embodiments herein, a method for facilitating anonymous audio and video communication between at least a first web browser and a second web browser, such as between at least a first user using a first web browser and at least a second user using a second web browser, via a server is provided. The method may comprise browsing to the server using the first web browser, establishing a signalling channel on the server and create a first unique identifier for the signalling channel. The first unique identifier may be at least temporarily stored at the server. The first unique identifier is transferred to the second user. The method may further comprise browsing to the first unique identifier using the second web browser, whereby an anonymous connection is established between the first web browser and the second web browser.

Other embodiments herein include corresponding devices, systems, and products, each yielding one or more of the benefits and advantages described in connection with the above-mentioned method.

According to still other embodiments herein, a web based system is provided and adapted to perform the steps of the method for facilitating anonymous audio and video communication. The web based system may comprise a first web browser facilitating audio and video communication,

a second web browser facilitating audio and video communication,
a server configured to create one or more signalling channel(s) and to temporarily store one or more corresponding unique identifier(s) of the signalling channel(s). Hereby, a first user using the first web browser and a second user using the second browser may communicate anonymously via the signalling channel(s) by using the unique identifier(s) of the signalling channel(s) in the respective web browsers.

It is an advantage of the above-described method that a first user using a web browser to establish a communication connection with a second user may establish the connection without having to login to a server and exchange initial information, such as user names and passwords, to be allowed access. Thereby, also no server back-end is required to maintain user names, passwords, and possibly more information, such as credit card or other payment information. It is an advantage of facilitating communication without using a server back-end as the server back-end is complex to administer and as a server back-end may be a target for intrusion attempts.

It is a further advantage of the present invention in one or more embodiments that two or more users may communicate via the web browsers regardless of the presence of specific plug-in programs, so that, for example, two users may communicate without having the same software plug-in installed on their respective communication device.

Preferably, the at least first web browser and the second web browser facilitate voice and video communication using an “out-of-band” signalling channel, such as by the first web browser and the second web browser implementing an RTC-Web standard.

The web browser may be accessed via any means generally capable of accessing web browsers, such as from any communication device, such as computers, such as mobile terminals, e.g. mobile telephones, pagers, communicators, electronic organisers, smart phones, personal digital assistants (PDAs), handheld computers, tablet computers, etc.

The signalling channel may be identified arbitrarily by assigning a universally unique identifier (UUID) or a random number for the unique identifier. It is an advantage of using a UUID or a random number for identifying the signalling channel(s) as such unique identifiers are hard-to-guess identifiers and unlikely to be hacked.

Preferably, the unique identifier is stored temporarily at the server. In one embodiment, the signalling channel may be reclaimed in that the first unique identifier is deleted from the server upon connection of the first and the second web browser. That is, as soon as the connection is established, only the signalling channel is maintained by the server.

In another embodiment, the first unique identifier is deleted from the server upon a first termination of the connection by the first and/or the second user. Thereby, the server maintains the first unique identifier during the call. Thus, the signalling channel may handle further requests and details, e.g. such as handling media format, adding/removing media streams, etc. Additionally, the first unique identifier may be deleted from the server upon reaching a time-out before a connection between the at least first and second web browsers is established.

Thus, according to one or more embodiments herein, it is not necessary to provide a fixed signalling channel assigned to a specific user, and likewise, it is not necessary to provide a unique identifier assigned to a specific channel or a specific user. The establishment and allocation of signalling channels to users may be dynamic processes and each new established signalling channel may be given a new unique identifier.

Preferably, the signalling channel is a bi-directional signalling channel. The bi-directional signalling channel may be implemented in any known manner. In one embodiment, a first bi-directional channel may be established between the first web browser and the server, and a second bi-directional channel may be established between the second web browser and the server, wherein the bi-directional signalling channel may be configured at the server to redirect incoming traffic by forwarding incoming messages from the first bi-directional channel to the second bi-directional channel. The first and second bi-directional channels may be implemented using any protocol, for example such as by using a Web Socket protocol.

The bi-directional signalling channel may also be implemented using first and second uni-directional signalling channels. The first uni-directional channel may be established at the server, and the corresponding first unique identifier may be created, and at least temporarily stored at the server. Thereafter, the first unique identifier may be transferred to the second web browser. The second uni-directional channel may then be established at the server upon browsing to the first unique identifier using the second web browser creating a second unique identifier. The bi-directional signalling channel may be established by pairing the first unique identifier identifying the first uni-directional channel with the second unique identifier identifying the second uni-directional channel. In one embodiment, each of the uni-directional channels may comprise a FIFO channel.

The unique identifier may be provided to the second user in the form of a URL. The URL may contain the unique identifier, or the URL may embed an encrypted version of the unique identifier.

The transfer of the first unique identifier to the second user may be performed by any known means, such as using electronic mail, SMS, IM, chats, voice communication, notes, or any other transfer, electronically or otherwise. Typically, it will be the responsibility of the first user to ensure that the unique identifier is not revealed to others, or eavesdropped, during transfer of the unique identifier from the first user to the second user. In such a case where the unique identifier is revealed to others or is eavesdropped, this will have effect only for the specific connection or session.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout. Like elements will, thus, not be described in detail with respect to the description of each figure.

### BRIEF DESCRIPTION OF THE DRAWINGS

The above and other aspects will be apparent and elucidated from the embodiments described with reference to the drawing in which:

FIG. 1 shows a schematic block diagram of an embodiment of a web system for facilitating anonymous communication between two users.

FIG. 2 shows a schematic flow chart of a method facilitating anonymous communication between two users.

FIG. 3 shows a schematic block diagram of another embodiment of a web system for facilitating anonymous communication between two users.

FIG. 4 shows a schematic flow chart of another method of facilitating anonymous communication between two users.

### DETAILED DESCRIPTION

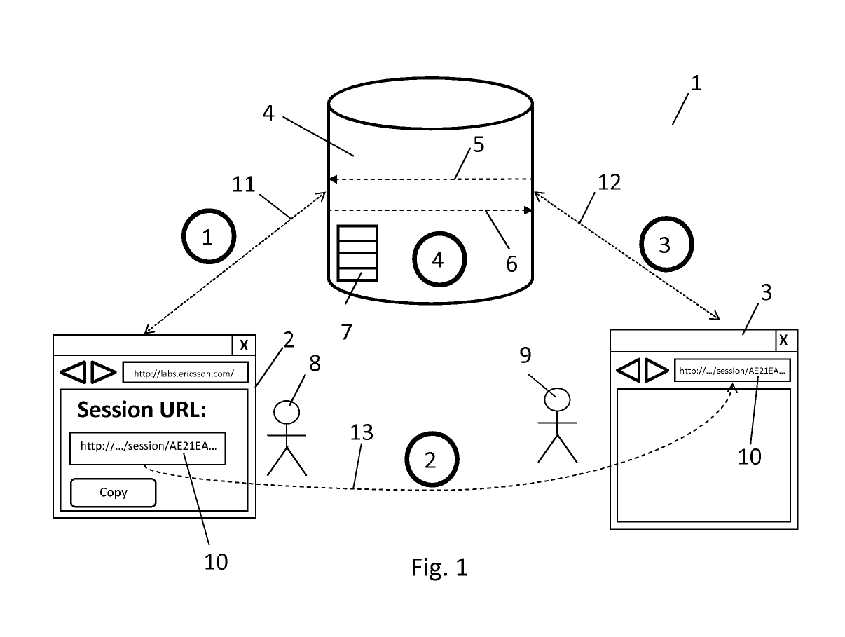

FIG. 1 shows a schematic block diagram of an exemplary web system 1 configured to perform the steps of the method for facilitating anonymous audio and video communication. The web based system 1 comprises a first web browser 2 facilitating audio and video communication and a second web browser 3 facilitating audio and video communication, and comprises furthermore a server 4 configured to create one or more signalling channel(s) 5, 6 and to temporarily store one or more corresponding unique identifier(s) 10 of the signalling channel(s) in a server storage 7. Hereby, a first user 8 using the first web browser 2 and a second user 9 using the second browser 3 may communicate anonymously via the signalling channel(s) 5, 6 by using the unique identifier(s) 10 of the signalling channel(s) 5, 6 in the respective web browsers 2, 3.

The server is connected to the first web browser 2 via a first bi-directional channel 11 and the server is connected to the second web browser 3 via a second bi-directional channel 12, for example via the internet. The link 13 between the first web browser and the second web browser is established by the first user 8 providing the unique identifier 10 in the first web browser 2 to the second user 9 for entering in the second web browser 3, for example by sending an SMS via a mobile phone.

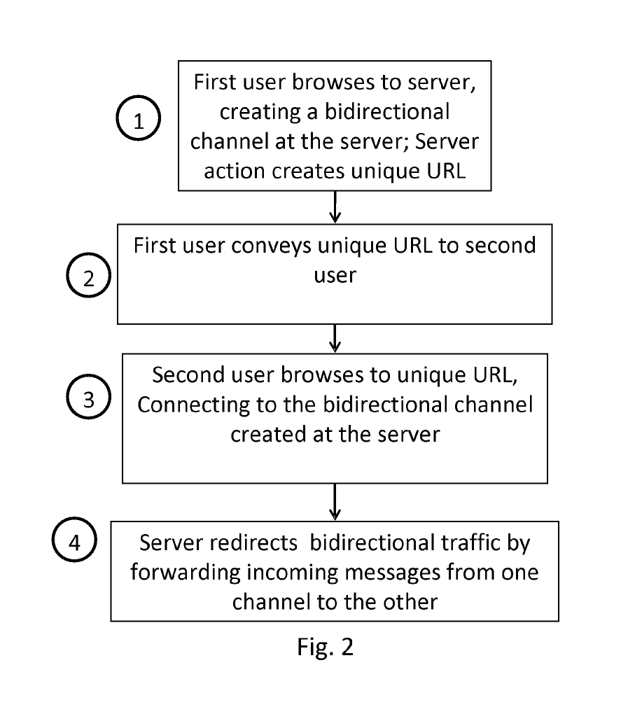

FIG. 2 shows a flow chart of a method facilitating anonymous communication between two users using for example a web system 1 as shown in FIG. 1. In step 1, the first user 8 browses to the server 4, thereby creating a first bi-directional channel 11 to the server and a bi-directional channel 5, 6 at the server. This server action creates a unique identifier 10, such as a unique URL, which is shown in the first web browser 2. In step 2 of the flow chart, the unique URL 10 is conveyed to the second user 9. In step 3, the second user browses to the unique URL, connecting to the bi-directional signalling channel created at the server 3. The server 3 redirects bi-directional traffic by forwarding incoming messages from one channel to another. Alternatively or intermediately, a first bi-directional channel may be formed between the first web browser 2 and the server 4, and a second bi-directional channel may be formed between the second web browser 3 and the server 4, the one and the other bi-directional channel being connected via the unique URL 10. Typically, the first and second bi-directional channels may be implemented using a Web Socket protocol.

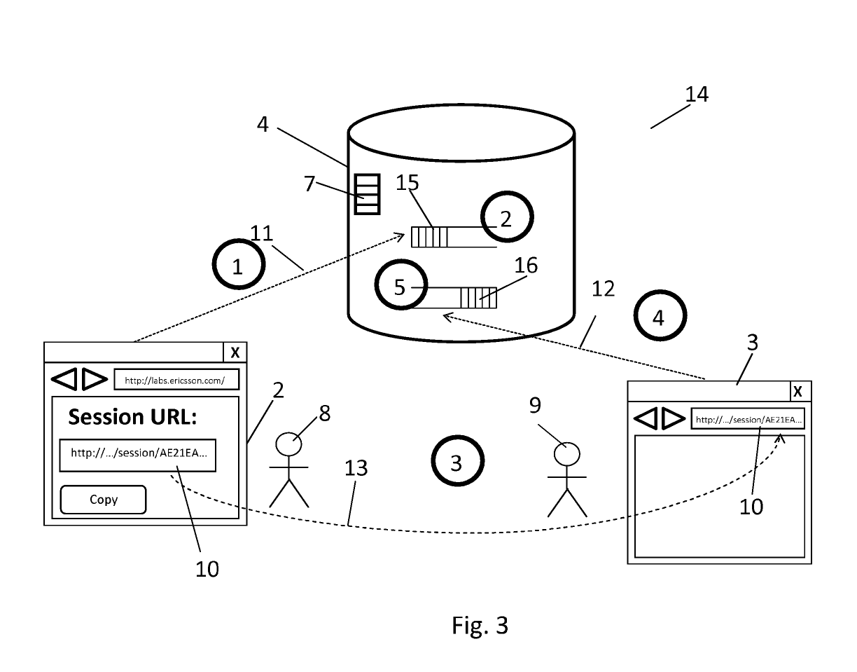

FIG. 3 shows a schematic block diagram of another exemplary web system 14 configured to perform the steps of the method for facilitating anonymous audio and video communication. The same reference numerals reference the same features as in FIG. 1. In this exemplary embodiment, the server creates a first uni-directional channel implemented by FIFO 15, and the server creates a second FIFO 16 when the second user 9 browses to the unique URL 10 received from the first user 8, and a corresponding second unique identifier.

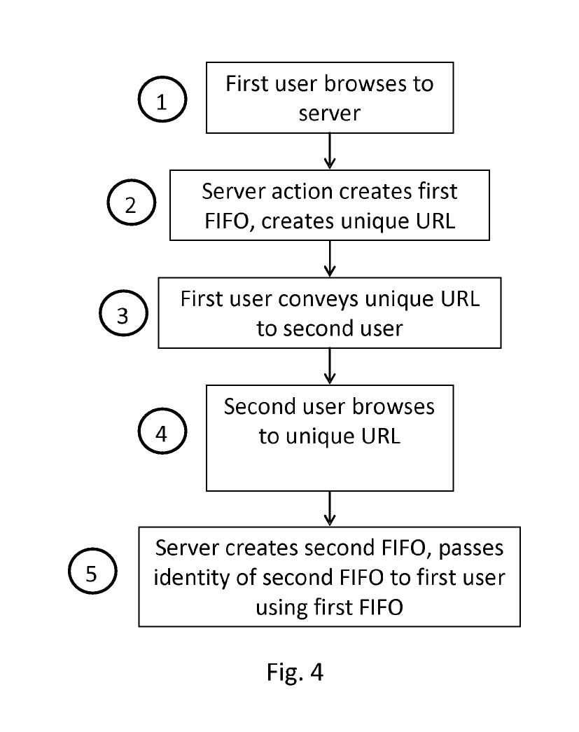

In FIG. 4, a flow chart of a method facilitating anonymous communication between two users using for example a web system 14 as shown in FIG. 3. In step 1, the first user 8 browses to the server 4. In step 2, the server creates a first FIFO 15 and assigns a unique identifier 10, such as a unique URL. The first user 8 conveys the unique URL 10 to the second user 9, in any manner (step three). In step four, the second user 9 browses to the unique URL 10 using the second web browser 3, and the server 4 creates the second FIFO 16 in step five, creates a second unique identifier (not shown) for the second FIFO and passes the identity of the second FIFO 16, i.e. the second unique identifier (not shown) to the first user 8 using the first FIFO 15 to thereby establish a bi-directional channel between the first web browser 2 and the second web browser 3.

1. A method implemented by a server for facilitating anonymous audio and video communication between a first web browser on a first communication device and a second web browser on a second communication device, the method comprising:
responsive to the first web browser browsing to the server, dynamically establishing a signalling channel on the server for the first web browser;
creating a first unique identifier for the established signalling channel;
temporarily storing the first unique identifier at the server;
sending the first unique identifier to the first web browser for transfer of the first unique identifier to the second web browser; and
responsive to the second web browser browsing to the server using the first unique identifier, connecting the second web browser to the established signaling channel for anonymous communication between the first and second web browsers over that channel.

2. The method according to claim 1, wherein the signalling channel is a bi-directional signalling channel.

3. The method according to claim 2, further comprising connecting to the first web browser over a first bi-directional channel responsive to the first web browser browsing to the server, connecting to the second web browser over a second bi-directional channel responsive to the second web browser browsing to the server, and forwarding incoming messages between the first and second bi-directional channels to facilitate communication over the established signaling channel.

4. The method according to claim 3, wherein the first and second bi-directional channels are implemented using a Web Socket protocol.

5. The method according to claim 2, further comprising connecting to the first web browser over a first uni-directional channel identified by the first unique identifier, connecting to the second web browser over a second uni-directional channel identified by a second unique identifier, and pairing the first and second unique identifiers for bi-directional communication over the established signaling channel.

6. The method according to claim 5, wherein each of the uni-directional channels comprises a FIFO channel.

7. The method according to claim 1, wherein creating the first unique identifier for the established signaling channel comprises assigning a universally unique identifier (UUID) or a random number to arbitrarily identify the established signaling channel.

8. The method according to claim 1, further comprising reclaiming the signalling channel by deleting the first unique identifier from temporary storage at the server upon establishment of the anonymous connection between the first and second web browsers, upon termination of the connection to at least one of the first and second web browsers, or upon expiration of a defined time period before the anonymous connection is established.

9. The method according to claim 1, wherein the signaling channel is an “out-of-band” signalling channel.

10. The method according to claim 1, wherein said sending comprises sending the first unique identifier to the first web browser in the form of a URL.

11. A server configured to facilitate anonymous audio and video communication between a first web browser on a first communication device and a second web browser on a second communication device, the server configured to:
responsive to the first web browser browsing to the server, dynamically establish a signalling channel on the server for the first web browser;
create a first unique identifier for the established signalling channel;
temporarily store the first unique identifier at the server;
send the first unique identifier to first web browser for transfer of that identifier to the second web browser; and
responsive to the second web browser browsing to the server using the first unique identifier, connect the second web browser to the established signaling channel for anonymous communication between the first and second web browsers over that channel.

12. The server according to claim 11, wherein the signalling channel is a bi-directional signalling channel.

13. The server according to claim 12, wherein the server is further configured to connect to the first web browser over a first bi-directional channel responsive to the first web browser browsing to the server, connect to the second web browser over a second bi-directional channel responsive to the second web browser browsing to the server, and forward incoming messages between the first and second bi-directional channels to facilitate communication over the established signaling channel.

14. The server according to claim 13, wherein the first and second bi-directional channels are implemented using a Web Socket protocol.

15. The server according to claim 12, wherein the server is further configured to connect to the first web browser over a first uni-directional channel identified by the first unique identifier, connect to the second web browser over a second uni-directional channel identified by a second unique identifier, and pair the first and second unique identifiers for bi-directional communication over the established signaling channel.

16. The server according to claim 15, wherein each of the uni-directional channels comprises a FIFO channel.

17. The server according to claim 11, wherein the server is configured to create the first unique identifier for the established signaling channel by assigning a universally unique identifier (UUID) or a random number to arbitrarily identify the established signaling channel.

18. The server according to claim 11, wherein the server is further configured to reclaim the signalling channel by deleting the first unique identifier from storage at the server upon establishment of the anonymous connection between the first and second web browsers, upon termination of the connection to at least one of the first and second web browsers, or upon expiration of a defined time period before the anonymous connection is established.

19. The server according to claim 11, wherein the signaling channel is an “out-of-band” signalling channel.

20. The server according to claim 11, wherein the server is configured to send the first unique identifier to the first web browser in the form of a URL.
